(19) United States
(12) Patent Application Publication
(10) Pub. No.: US 2025/0351989 A1
(43) Pub. Date: Nov. 20, 2025

(54) HOUSEHOLD CITRUS JUICER

(71) Applicant: I-TECH USA, INC., Farmington Hills, MI (US)

(72) Inventor: Ji Young Yoo, Rochester Hills, MI (US)

(21) Appl. No.: 19/284,126

(22) Filed: Jul. 29, 2025

Related U.S. Application Data
(63) Continuation-in-part of application No. 18/922,922, filed on Oct. 22, 2024.
(60) Provisional application No. 63/592,632, filed on Oct. 24, 2023.
(60) Provisional application No. 63/561,025, filed on Mar. 4, 2024.
(60) Provisional application No. 63/643,581, filed on May 7, 2024.

(51) Int. Cl. A47J 19/02; A23L 2/06

(52) U.S. Cl. CPC A47J 19/025; A23L 2/06

(57) ABSTRACT

The present disclosure provides a household citrus juicer for juicing fruit. The household citrus juicer can include a housing, a lid, a juicing assembly, a motor, a juice port, and a waste receptacle. The juicing assembly can include an outer auger, an inner auger, a slide, and a guide vane. The outer auger can include inner gear teeth, and the inner auger can include outer gear teeth. The outer gear teeth of the inner auger can be intermeshed with the inner gear teeth of the outer auger. The inner auger and the outer auger can be configured to selectively move to squeeze the fruit at the juicing point to produce juice and waste.

### CROSS-REFERENCE TO RELATED APPLICATIONS

This application is a continuation-in-part of U.S. patent application Ser. No. 18/922,922 filed on Oct. 22, 2024, which claims the benefit of U.S. Provisional Application No. 63/643,581, filed on May 7, 2024, U.S. Provisional Application No. 63/561,025, filed on Mar. 4, 2024, and U.S. Provisional Application No. 63/592,632, filed on Oct. 24, 2023. The entire disclosures of the above applications are incorporated herein by reference.

### FIELD

The present technology relates to juicers and, more specifically, household citrus juicers.

### INTRODUCTION

This section provides background information related to the present disclosure which is not necessarily prior art.

Citrus juicers are common kitchen appliances designed to extract the juice from various citrus fruits, such as oranges, lemons, limes, and grapefruits. These juicers have become popular due to their efficiency in quickly obtaining fresh citrus juice for cooking, baking, and beverages. Citrus juicers come in a variety of designs and mechanisms, catering to different user preferences and needs.

The history of citrus juicers dates back centuries when people first discovered the refreshing and tangy taste of citrus fruits. Early methods of extracting juice involved manual squeezing using hands or simple tools like reamers. These manual methods were labor-intensive and inefficient for larger quantities of juice. Advancements in kitchen technology and the rise of household appliances led to the development of mechanical juicers. Early juicers featured hand-crank mechanisms and lever systems to aid in juice extraction. As time has progressed, various types of citrus juicers have emerged, each offering improvements in efficiency and ease of use.

There are several types of mechanical citrus juicers including manual reamers, hand press juicers, and electric citrus juicers. Manual reamers allow for handheld, manual use with a conical shape that fits into a half-cut fruit. By twisting and pressing the reamer into the fruit, the juice is extracted. Manual reamers are simple and affordable options but require physical effort. Hand press juicers feature a lever mechanism that presses down on the citrus fruit placed on a ridged surface. This lever action extracts juice by exerting force on the fruit. Hand press juicers are commonly used in both households and commercial settings. Electric juicers are motorized devices that automate the juice extraction process and come with various attachments to accommodate different citrus fruit sizes. Some models rotate the fruit on a reamer, while others use a spinning cone to extract the juice.

Electric citrus juicers can be time efficient for juicing a large quantity of citrus fruits and can also exert the greatest force to collect the most juice possible. However, the force exerted upon the fruit when using an electric citrus juicer should be optimized for the shape, size, and density of the fruit. Complications can arise if the juicing mechanism becomes clogged with pulp as the juicing takes place.

Accordingly, there is a need for a citrus juicer with improved operability that militates against clogging.

### SUMMARY

In concordance with the instant disclosure, a citrus juicer with enhanced operability features that militate against clogging, has surprisingly been discovered. The present technology includes articles of manufacture, systems, and processes that relate to household citrus juicers. Specifically, the technology relates to a household citrus juicer designed for efficient juicing of citrus fruits while providing enhanced operability features that militate against clogging.

The present disclosure provides a household citrus juicer for juicing fruit. The household citrus juicer can include a housing, a lid, a juicing assembly, a motor, a juice port, and a waste receptacle. The lid can include a chute and can be configured to move between an open position and a closed position. The juicing assembly can include an outer auger, an inner auger, a slide, and a guide vane. The outer auger can include inner gear teeth, and the inner auger can include outer gear teeth. The outer gear teeth of the inner auger can be intermeshed with the inner gear teeth of the outer auger. The inner auger can further include fins. The slide can be configured to guide the fruit to a juicing point defined by a gap between the inner gear teeth of the outer auger and the outer gear teeth of the inner auger. The guide vane can be disposed adjacent to the slide and the inner auger. The inner auger and the outer auger can be configured to selectively move to squeeze the fruit at the juicing point to produce juice and waste. The motor can be configured to rotate the inner auger, and the inner auger can be configured to rotate the outer auger via the intermeshed inner gear teeth and outer gear teeth. The juice port can be in fluid communication with the juicing assembly and can be configured to receive the juice from the fruit squeezed at the juicing point of the juicing assembly. The waste receptacle can be configured to receive the waste from the juicing assembly.

The present disclosure further provides a household citrus juicer kit. The kit can include the citrus juicer of the present disclosure. The kit can further include a first sleeve of a first diameter and a second sleeve of a second diameter. The second diameter can be different from the first diameter. In this way, the first sleeve can be detached and replaced with a second sleeve allowing for adjustment of the distance between the inner auger and the outer auger.

The present disclosure also provides a method for using a household citrus juicer. The method can include a step of providing the juicer of the present disclosure and a step of installing the sleeve onto the inner auger. The sleeve can change the gap between the inner gear teeth of the outer auger and the outer gear teeth of the inner auger.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a top perspective view of a household citrus juicer;

FIG. 2 is a cross-sectional view of the household citrus juicer, taken at section line A-A as shown in FIG. 1;

FIG. 3 is a top plan view of a juicing assembly of the household citrus juicer;

FIG. 4 is a perspective view of the juicing assembly of the household citrus juicer;

FIG. 5 is an exploded view of the juicing assembly and a lid of the household citrus juicer;

FIG. 6a is a sectional view of the juicing assembly with a piece of fruit moving down a slide toward a juicing point;

FIG. 6b is a sectional view of the juicing assembly with the piece of fruit entering the juicing point and being juiced using an inner auger and an outer auger;

FIG. 6c is a sectional view of the juicing assembly with the piece of fruit exiting the juicing point after being juiced by the inner auger and the outer auger with juice flowing toward a juice port;

FIG. 6d is a sectional view of the juicing assembly with the piece of fruit falling into a waste receptacle after being juiced;

FIG. 7 is a side elevational view of sleeves having different diameters for the inner auger provided in a household citrus juicer kit;

FIG. 8 is a schematic of the household citrus juicer kit;

FIG. 9 is a flow chart depicting a method for using a household citrus juicer;

FIG. 10 is a cutaway prospective view of the juicing assembly of the household citrus juicer;

FIG. 11 is an exploded view of the juicing assembly and a lid of the household citrus juicer; and

FIG. 12 is a top perspective view of a cover of the juicing assembly.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

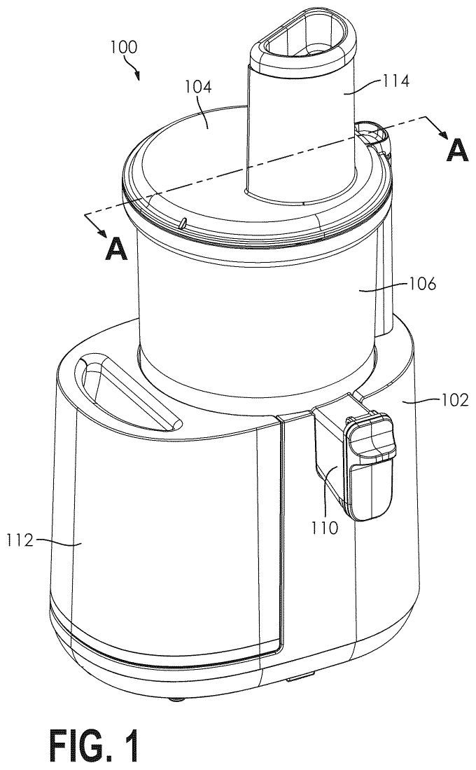

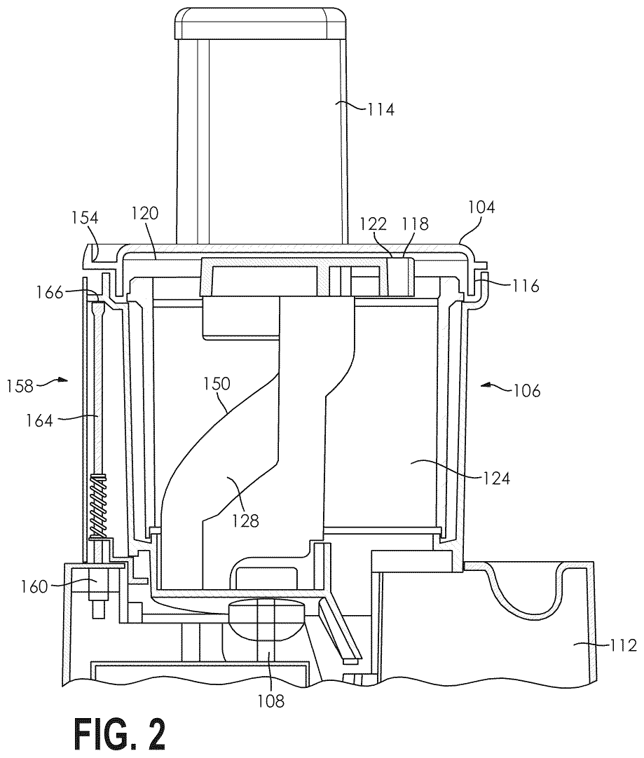

The present technology provides a household citrus juicer 100 as shown generally in FIGS. 1-8. The household citrus juicer 100 can include a housing 102, a lid 104, a juicing assembly 106, a motor 108, a juice port 110, and a waste receptacle 112, as shown in FIGS. 1-2. Advantageously, the household citrus juicer 100 can provide additional operational controls while also efficiently juicing citrus fruit. It should be appreciated that the household citrus juicer 100 is for use as a household appliance, which is configured to be placed atop a standard-sized household countertop or table. Importantly, the household citrus juicer 100 of the present disclosure does not have dimensions suitable for commercial juicing operations, and as would be understood by one skilled in the art.

As described herein, in a preferred embodiment, the household citrus juicer 100 can have dimensions suitable for household use. With respect to specific dimensions provided, it should be appreciated that ranges extending plus or minus about twenty percent (±20%) of the target dimension, more particularly plus or minus about ten percent (±10%) of the target dimension, and most particularly plus or minus about five percent (±5%) of the target dimension is considered be within the scope of the present disclosure.

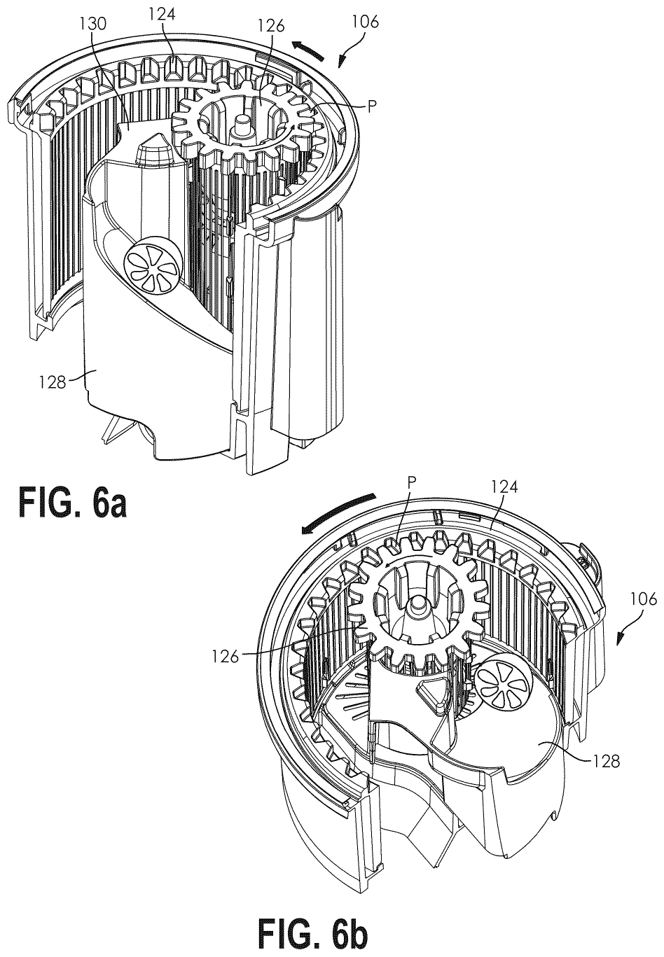

With reference to FIGS. 1 and 5, the household citrus juicer 100 can include the lid 104. The lid 104 can act as a cover for the juicing assembly 106 and incorporate a chute 114 for feeding fruit into the juicing assembly 106. The lid 104 can move between an open position, as shown in FIG. 5, allowing access to the juicing assembly, and a closed position for operation, as shown in FIG. 1. To secure the lid 104 to the juicing assembly 106, the lid 104 can include a coupling means 116. In a particular embodiment, the coupling means 116 be positioned on an underside 120 of the lid 104 and can include one or more projections 118 configured to cooperate and engage with one or more portions of the juicing assembly 106 to tighten the lid 104 onto the juicing assembly 106. For example, the coupling means 116 can include a threaded coupling means, a snapping coupling means, or a tabbed coupling means. A skilled artisan can select a suitable size, shape, and location for the coupling means 116 within the scope of the present disclosure.

Advantageously, the coupling means 116 can facilitate a secure fit and liquid-tight seal between the lid 104 and the juicing assembly 106 when the lid 104 is in the closed position, militating against liquid leaking from the juicing assembly 106 in operation. Embodiments include where the coupling means 116 has a gasket for creating the liquid-tight seal between the lid 104 and the juicing assembly 106. Desirably, the liquid-tight seal serves to contain the juice within the juicing assembly 106, directing the juice towards the juice port 110 for collection. The containment of the juice allows for efficient juice extraction and also maintains cleanliness during operation.

The lid 104 can include the chute 114 disposed on a top of the lid 104. The chute 114 can allow the user to feed fruit into the lid 104 when the lid 104 is in the closed position, as shown in FIG. 1. With reference to FIG. 5, the shape of the chute 114 can be derived from a circular shape. The shape can be sized such that fruits that are cut into both halve sizes and quarter sizes can easily slide down through the chute 114 and into the juicing assembly 106. The shape of the chute 114 can facilitate the user inserting the fruit with the skin side facing an exterior of the juicing assembly 106 and the pulpy side facing an interior of the juicing assembly 106. Accordingly, the chute 114 can be shaped to allow for fruit to be easily added to the household citrus juicer 100 as selected by a skilled artisan. Additionally, the chute 114 can be sized and shaped to adhere with appliance regulations, as required.

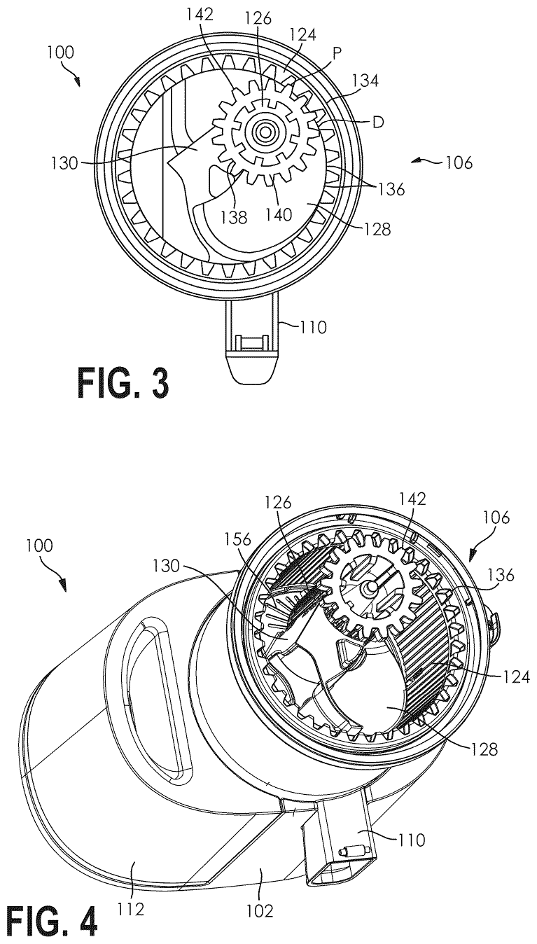

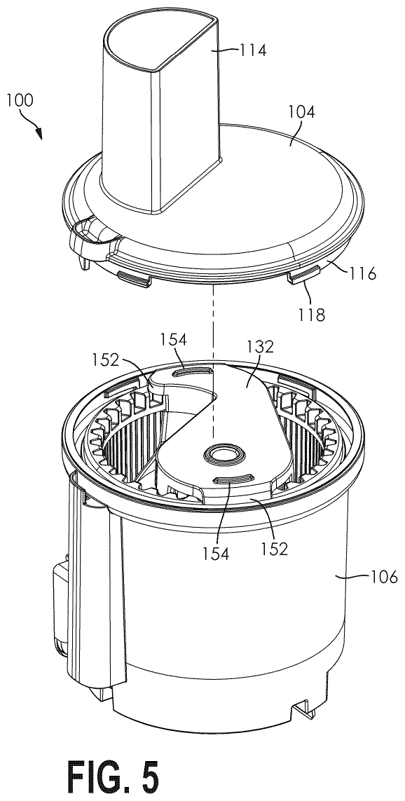

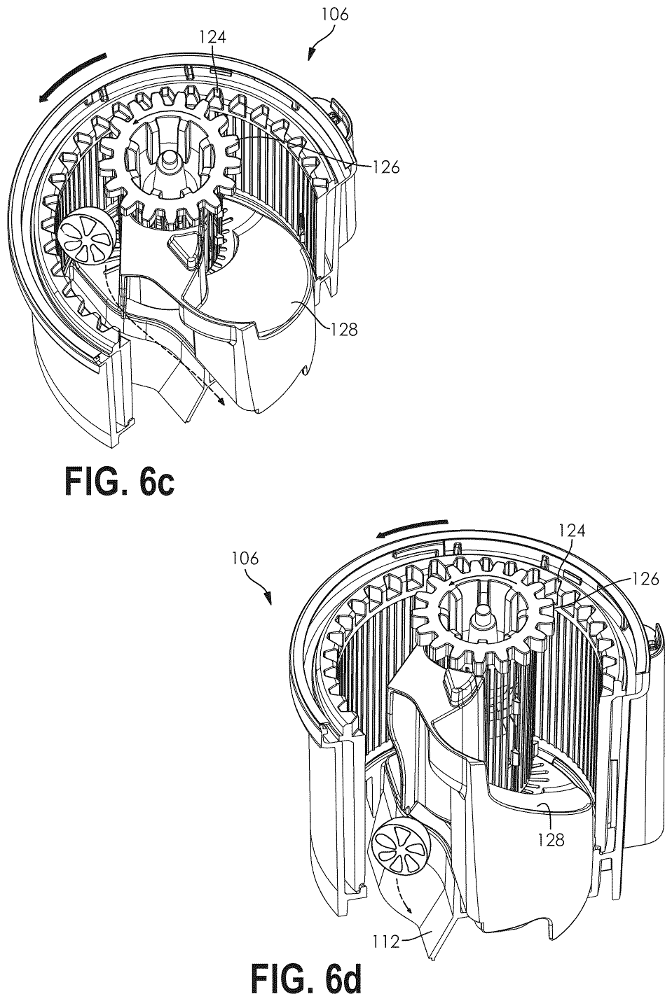

With reference to FIGS. 4-6d, the juicing assembly 106 can include an outer auger 124, an inner auger 126, a slide 128, a guide vane 130, and a cover 132. In operation, the fruit can be guided by the chute 114 and slide 128 toward a juicing point (P), which can be defined by a gap between the outer auger 124 and the inner auger 126. The motor 108 can rotate the inner auger 126 counterclockwise, which, in turn, can rotate the outer auger 124 counterclockwise, as shown in FIGS. 6a-6d. As the fruit reaches the juicing point (P), it is squeezed between the inner auger 126 and the outer auger 124. The motor 108 can continue to rotate the inner auger 126 forcing the fruit through the juicing point (P) and toward the waste receptacle 112 and juicer port 110. The juicing assembly 106 can have a varying volume from entry to exit to facilitate the squeezing process, as shown in FIG. 3.

As shown in FIGS. 3-4, the juicing assembly 106 can include the outer auger 124 and the inner auger 126. The outer auger 124 can be disposed along an inner perimeter 134 of the juicing assembly and can be moveable within the juicing assembly 106. The outer auger 124 can have inner gear teeth 136 disposed along the inner perimeter 134 of the juicing assembly 106. The inner auger 126 can be disposed adjacent the outer auger 124 and offset from a center 138 of the juicing assembly 106, as shown in FIG. 3. The inner auger 126 can have a sleeve 140 having an outer gear teeth 142 and a fin 144. The outer gear teeth 142 of the inner auger 126 can intermesh with the inner gear teeth 136 of the outer auger 124. The intermeshed inner gear teeth 136 of the outer auger 124 and the outer gear teeth 142 of the inner auger 126 permit that as the inner auger 126 rotates driven by the motor 108, the outer auger 124 can move with the inner auger 124. In this way, the outer auger 124 and the inner auger 126 can rotate in the same direction. For example, where the slide 128 directs the fruit clockwise toward the juicing point (P), the outer auger 124 and the inner auger 126 can rotate counterclockwise (as depicted by the arrows) to move the fruit to and through the juicing point (P), as shown in FIGS. 6a-6d. It should be appreciated that the offset position of the inner auger 126 within the juicing assembly 106 can create a varying volume within the juicing assembly 106 from where the fruit enters the juicing assembly 106 directly under the chute 114 to the juicing point (P), as shown in FIG. 3.

The outer gear teeth 142 of the inner auger 126 and inner gear teeth 136 of the outer auger 124 can be separated by a distance (D), as shown in FIG. 3, large enough to allow the fruit peels and pulp to move past the juicing point (P) and into the waste receptacle 112. The outer gear teeth 142 and inner gear teeth 136 can work to grip the fruit peels and move the fruit peel toward the juicing point (P) for juicing. Additionally, in a preferred embodiment, the inner auger 126 can have a diameter of about 55 mm. A skilled artisan can select a suitable size for the inner auger 126 within the scope of the present disclosure. It should also be appreciated that, in a preferred embodiment, the outer auger 124 can have a height of about 131 mm and a diameter of about 156 mm. A skilled artisan can select a suitable size for the inner auger 126 within the scope of the present disclosure. A skilled artisan can select a suitable size for the outer auger 124 within the scope of the present disclosure. Further, the inner auger 126 can be interchangeable either by complete replacement or by adding sleeves on top of it to change the size of the inner auger 126. In this way, the distance (D) between the inner auger 126 and outer auger 124 can be altered to accommodate different citrus fruits with varying skin thickness.

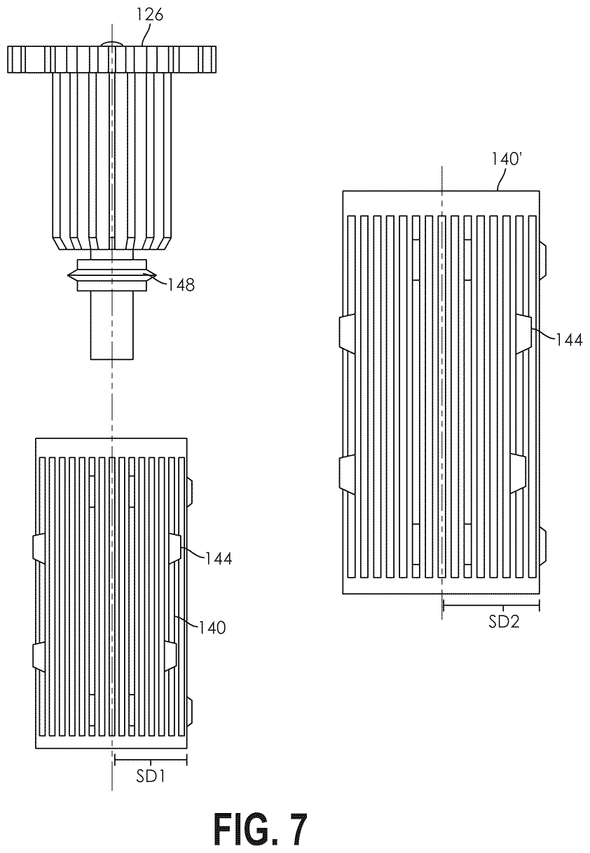

To accommodate varying sizes of fruit, the inner auger 126 can include the sleeve 140 with the outer gear teeth 142 that intermesh with the inner gear teeth 136 of the outer auger 124, allowing for synchronized rotation during the juicing process. The sleeve 140 can be interchangeable and selectively removable from the inner auger 126. In this way, the sleeve 140 can be detached and replaced with a second sleeve 140′ of a different size, allowing for adjustment of the distance (D) between the inner and outer augers, as depicted in FIG. 7. The sleeve 140 can have a first diameter (SD1) that results in the distance (D) between the inner auger 126 and the outer auger 124. However, it should be appreciated that the sleeve 140 can be switched out for the second sleeve 140′ having a second diameter (SD2) that results in a second distance (D) between the inner auger 126 and the outer auger 124. The distance (D) can be different than the second distance to allow for the household citrus juicer 100 to accommodate fruit of various sizes. For example, when juicing a lime, which has a relatively small diameter, the distance (D) between the inner auger 126 and the outer auger 124 can be smaller than when juicing a grapefruit, which has a relatively large diameter. In a particular example, the sleeve 140 and the second sleeve 140′ can create gaps with a distance (D) ranging from about 3 mm to about 5 mm between the inner auger 126 and the outer auger 124.

The inner auger 126 also includes a bushing 148 for holding the sleeve 140 in place during use. The bushing 148 can be formed of rubber, for example, due to the flexibility, durability, and ability to create a secure fit. A skilled artisan can select a suitable material for the bushing 148 within the scope of the present disclosure. The bushing 148 can be disposed inside the sleeve 140 and outside of the inner auger 126. The bushing 148 can work by providing a snug fit between the inner auger 126 and its sleeve 140, promoting stability and alignment of the sleeve 140 in operation.

The inner auger 126 can include the fin 144. The fin 144 can be disposed on an outer surface of the inner auger 126. The fin 144 can be configured to directly contact the fruit in operation. The fin 144 can work in cooperation with the outer gear teeth 142 to grip the fruit as the fruit moves through the juicing assembly toward the juicing point (P) and through the juicing point (P). The fin 144 can have a large surface area to allow for better grabbing action on the fruit. The gripping action can move the fruit towards the juicing point (P) and maintain the position of the fruit at the juicing point (P) during the squeezing process. As an example, the inner auger 126 can include more than one fin 144, each disposed at various points along the circumference of the inner auger 126 and along the height of the inner auger 126.

It should be appreciated that the size of the fin 144 requires a balance between being large enough to grip the fruit while maintaining a small enough size to permit the inner auger 126 to rotate within the outer auger 124. In other words, the depth of which the fin 144 extends from the inner auger 126 must be less than the distance (D) between the inner auger 126 and the outer auger 124. In this way, the outer auger 124 and the inner auger 126 can effectively cooperate to juice the fruit while militating against interference or jamming by the fin 144. A skilled artisan can select a suitable size for the fin 144 within the scope of the present disclosure. Advantageously, the sleeve 140 and fin 144 promote improved fruit gripping, enhanced juice extraction, adaptability to different types and sizes of citrus fruits, increased efficiency in juicing operations, and militate against clogging or jamming of the household citrus juicer 100.

With reference to FIG. 3, the juicing assembly 106 can include the slide 128 configured to guide the fruit to the juicing point (P). The slide 128 can be disposed within the juicing assembly 106 between the chute 114 of the lid 104 and the juicing point (P) where the inner auger 126 and the outer auger 124 meet. The slide 128 can have a sloped upper surface 150 to allow the fruit placed into the juicing assembly 106 to slide or roll toward the juicing point (P), as shown in FIG. 3. It should be appreciated that the top of the slide 128 is disposed adjacent to the exit point of the chute 114 such that when fruit falls through the chute 114 into the juicing assembly 106, the fruit slides or rolls down the slide 128. Advantageously, the slide 128 can facilitate fruits of all sizes, including smaller fruits like limes, to reach as close to the juicing point (P) as possible during the initial drop of the fruit from the chute 114 into the juicing assembly 106. Without the sloped upper surface 150, smaller fruits might fall and remain stationary outside the reach of either of the inner auger 126 or the outer auger 124. A skilled artisan can select a suitable slope for the sloped upper surface 150 to move fruit toward the juicing point (P) within the scope of the present disclosure.

As shown in FIG. 4, the juicing assembly 106 can include the guide vane 130. The guide vane 130 can be disposed adjacent to the chute 114 and the inner auger 126. The guide vane 130 can ensure that the skin of the fruit does not stick to the inner auger 126 after juicing. The guide vane 130 can also maintain a vertical alignment for the pulp pulled from the fruit to facilitate its fall into the waste receptacle 112 as soon as the juicing process is complete. The guide vane 130 can be positioned within the juicing assembly 106 directly adjacent to the inner auger 126 such that a minimal gap, or alternatively, no gap, exists between the guide vane 130 and the inner auger 126. The guide vane 130 can militate against pulp from entering the gap between the guide vane 130 and the inner auger 126 to facilitate the pulp moving in a vertical orientation until it reaches a falling point and lands in the waste receptacle 112. Advantageously, the guide vane 130 can aid with juicer efficiency and cleanliness by addressing the issue of pulp sticking to the inner auger 126 and becoming lodged between the slide 128 and the inner auger 126.

With reference to FIG. 5, the juicing assembly 106 can include the cover 132 configured to align the inner auger 126 within the juicing assembly 106. Additionally, the cover 132 can assist in maintaining the position of the inner auger 126 within the juicing assembly 106 when the lid 104 is moved between the open position and the closed position, providing stability for consistent juicing. The cover 132 can be disposed adjacent to the inner auger 126 and remain in place during operation due to an overhang 152 of the cover 132, as shown in FIG. 5. The cover 132 can also be coupled to the outer auger 124 using the overhang 152. The cover 132 can include a tab 154 disposed on a top side of the cover 132, as shown in FIG. 5. The tab 154 can be configured to press against the lid 104 when the lid 104 is in the closed position, securing and maintaining alignment of the lid 104, inner auger 126, and cover 132 during operation. The cover 132 can be shaped to fully cover the top of the inner auger 126 without interfering or blocking where the chute 114 of the lid 104 deposits the fruit into the juicing assembly 106. In this way, the inner auger 126 can remain in alignment while militating against interference of the fruit entering the juicing assembly 106.

With reference to FIG. 2, the household citrus juicer can include a motor 108. The motor 108 can be disposed within the housing 102 of the household citrus juicer 100 and can be in communication with the inner auger 126. As the motor 108 rotates the inner auger 126, the inner auger 126, in turn, can rotate the outer auger 124 via the intermeshed inner gear teeth 136 and outer gear teeth 142. The rotational motion can drive the juicing process, allowing the outer auger 124 and the inner auger 126 to squeeze the fruit at the juicing point (P) to produce juice and separate waste. As examples, several types of motors 108 can be used in the household citrus juicer 100, including an AC (Alternating Current) motors, a DC (Direct Current) motor, a brushless DC motor, and a universal motor. The choice of motor can depend on factors such as the required power output, efficiency, and noise levels. A skilled artisan can select a suitable motor 108 for the household citrus juicer 100 within the scope of the present disclosure.

With reference to FIG. 4, the juicing assembly 106 can include a filter 156 disposed below the juicing point (P). The filter 156 can separate the juice from pulp and other solid materials as the fruit is squeezed between the inner auger 126 and the outer auger 124. As the fruit is squeezed between the inner and outer augers at the juicing point (P), the extracted juice can pass through the filter 156 in the juicing assembly 106 before flowing out through the juice port 110.

With reference to FIG. 1, the household citrus juicer 100 can include the juice port 110. The juice port 110 can be in fluid communication with the juicing assembly 106 and can be configured to receive the juice from the fruit squeezed at the juicing point (P) of the juicing assembly 106. The juice port 110 can be disposed at a bottom of the juicing assembly 106 so that gravity can assist the juice in moving toward the juice port 110 to exit the juicing assembly 106 and household citrus juicer 100 generally. As shown in FIG. 1, the juice port 110 can be shaped and angled to allow juice to flow from the juicing assembly 106. The shape and angle of the juice port 110 can allow for cleaning, militate against drips or spills, and provide compatibility with various container sizes. A skilled artisan can select a suitable shape and angle for the juice port 110 within the scope of the present disclosure.

With reference to FIG. 1, the household citrus juicer 100 can include the waste receptacle 112 configured to receive the waste from the juicing assembly. The waste receptacle 112 can be an integral component of the household citrus juicer 100. Alternatively, the waste receptacle 112 can be selectively removable from the household citrus juicer 100. The waste receptacle 112 can include multiple purposes, including efficient waste collection, separation of juice and waste, and incorporation of a switch feature. As an example, the waste receptacle 112 can be formed of transparent material to allow for a user to easily see that the waste receptacle 112 should be emptied after use. Providing visibility of the capacity of the waste receptacle 112 can also militate against fruit becoming stuck in the juicing assembly 106 due to the waste receptacle 112 being full. A skilled artisan can select a suitable material for forming the waste receptacle 112 within the scope of the present disclosure.

It should be noted that the household citrus juicer 100 can further include a juice cup (not shown) for the user to collect juice dispensed from the household citrus juicer 100. The cup can be stored in the waste receptacle 112 when the household citrus juicer 100 is not in use. In this way, the waste receptacle 112 can be configured to accommodate a juice cup inside.

With reference to FIG. 2, the housing 102 can include an operational switch 158 configured to selectively permit operation of the motor 108. The operational switch 158 can include a first operational switch 160 activated when the juicing assembly 106 is coupled to the housing 102 and a second operational switch (not shown) activated when the waste receptacle 112 is coupled to the housing. Activation of both the first operational switch 160 and the second operational switch can be necessary to selectively permit operation of the motor 108. The first operational switch 160 can be configured to be activated when the juicing assembly 106 is coupled to the housing 102, and the second operational switch can be configured to be activated when the waste receptacle 112 is coupled to the housing 102. The operational switch 158 can be a tactile mechanical switch that is activated by both the juicing assembly 106 and the waste receptacle 112 being placed into or coupled with the housing 102. The household citrus juicer 100 can be configured to only operate where both the juicing assembly 106 and the waste receptacle 112 are in the housing 102. The operational switch 158 can militate against the household citrus juicer 100 turning on without the juicing assembly 106 and the waste receptacle 112 being in place in the housing.

As an example, the operational switch 158 can include a spring-loaded push rod 164. The 104 can include a flange 166 configured such that when the lid 104 is in the closed position, the flange 166 can push the spring-loaded push rod 164 down. A bottom of the push rod 164 can have a magnet, which can trigger a Hall sensor on the household citrus juicer 100 such that when the magnet passes through the Hall sensor, the Hall sensor can be triggered and allow for operation of the household citrus juicer 100. Therefore, when the lid 104 is in the open position, the flange 166 does not push down on the push rod 164, the Hall sensor is not triggered, and the household citrus juicer 100 cannot operate.

It should be appreciated that the housing 102 can be formed of a durable, food-safe material that can withstand regular use and cleaning. Common materials for kitchen appliances such as household citrus juicers 100 include various plastics, metals and composites, including stainless steel, or a combination of materials. The lid 104 can also be formed of a food-safe, impact-resistant material such as BPA-free plastic or food-grade stainless steel. A skilled artisan can select suitable materials for forming the housing 102 and the lid 104 within the scope of the present disclosure.

The household citrus juicer 100 can include a latch mechanism (not shown). The latch mechanism can be configured to keep the lid 104 stationary during the juicing process. The latch mechanism can include a latch that connects the lid 104 to the housing 102, with a first end disposed adjacent to the lid 104 and a second end disposed adjacent to the housing 102.

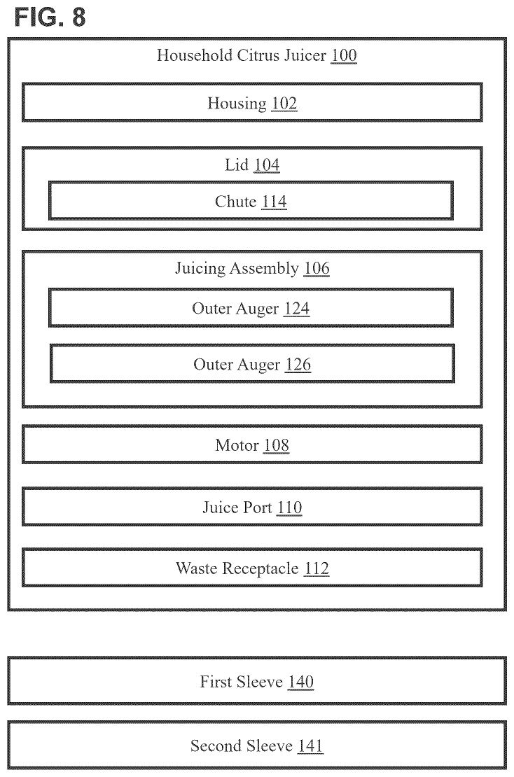

The present disclosure further provides a household citrus juicer kit 200, as shown in FIG. 8. The kit 200 can include the household citrus juicer 100 of the present disclosure. The kit 200 can allow for adjusting the gap between the inner auger 126 and the outer auger 124 to accommodate different citrus fruits. The kit 200 can further include the first sleeve 140 having the first diameter (SD1) and the second sleeve 140′ having a second diameter (SD2). The second diameter (SD2) can be different from the first diameter (SD1). In this way, the first sleeve 140 can be detached from the inner auger 126 and replaced with the second sleeve 140′ allowing for adjustment of the distance (D) between the inner auger 126 and the outer auger 124. The first diameter (SD1) can be larger than the second diameter (SD2). It should be appreciated that the fin 144 of the second sleeve 140′ can project outward from the second sleeve 140′ a greater distance than the fin 144 of the first sleeve 140.

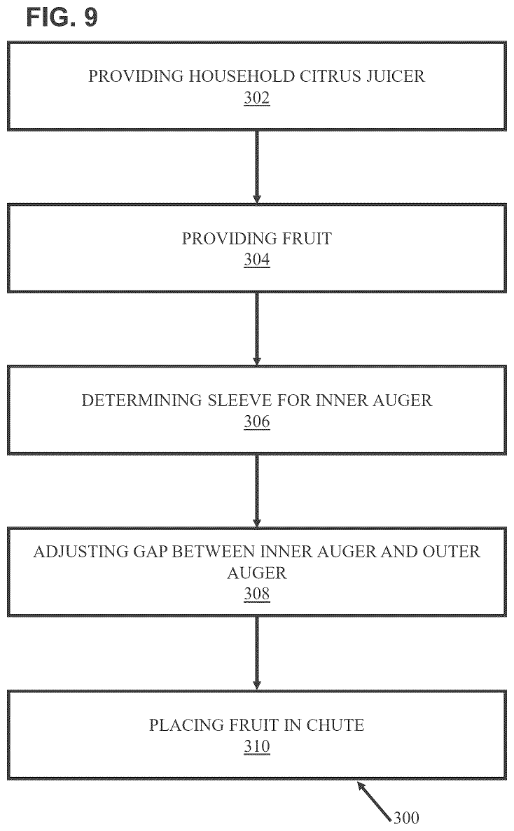

The present disclosure further provides a method 300 for using a household citrus juicer 100, shown generally in FIG. 9. In a step 302, the household citrus juicer 100, as described herein, can be provided. In a step 304, the user can provide fruit for juicing in the household citrus juicer 100, preferably cut into halves or quarters to facilitate juicing. In a step 306, the user can determine the appropriate sleeve 140 for use with the inner auger 126 to optimize juicing and allow the juicing assembly 106 to have a large enough gap between the inner auger 126 and the outer auger 124 to allow for the peel and pulp to move through the juicing point (P) while providing a small enough gap between the inner auger 126 and the outer auger 124 to effectively juice the fruit. The user can install the sleeve 140 onto the inner auger 126 to adjust the gap between the inner auger 126 and the outer auger 124 in a step 308. In a step 310, the user can place the fruit into the chute 114 for juicing the fruit.

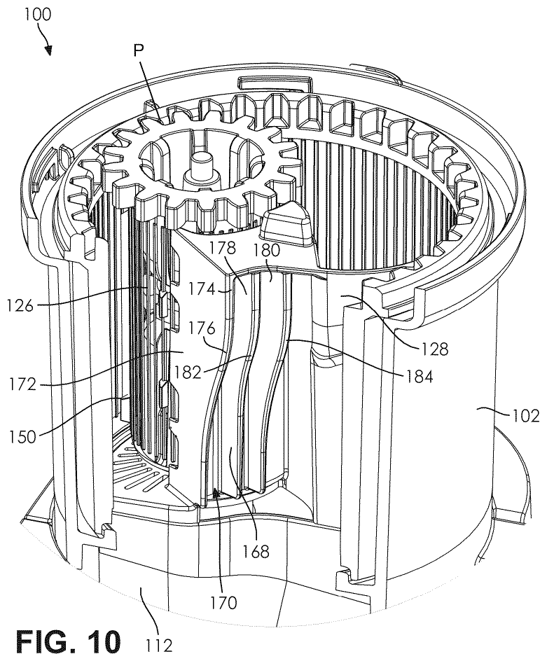

In certain embodiments, as shown in FIG. 10, the slide 128 can include a rib 168 disposed adjacent the inner auger 126. The rib 168 can run vertically adjacent the sloped upper surface 150. The slide 128 can include more than one rib 168. Where the fruit has moved through the juicing assembly 106, the rib 168 can militate against the pump from the fruit accumulating on a portion of the slide 128 between the slide 128 and the outer auger 124 after the juicing point (P). The rib 168 can assist with moving the fruit toward the waste receptacle 112 to militate against the fruit gathering in the 102 and resulting in the lid 104 becoming disengaged from the housing 102 and the household citrus juicer 100 shutting off.

With continued reference to FIG. 10, the rib 168 can be disposed within a cavity 170 adjacent the sloped upper surface 150 of the slide 128. The rib 168 can hang from an upper surface of the cavity 170 such that a bottom of the rib 168 can be free from the slide 128. The cavity 170 can have an outer wall 172 disposed adjacent the inner auger 126. The outer wall 172 can have a varied width such that a top of the outer wall 172 has a different width than a bottom of the outer wall 172. For example, the top of the outer wall 172 can have a larger width than the bottom of the outer wall 172. In this way, the outer wall 172 can have a curved edge 174 to account for the varied width. The outer wall 172 can have an outer wall curved portion 176 disposed substantially half way between the top of the outer wall 172 and the bottom of the outer wall 172.

The ribs 168 can include a first rib 178 and a second rib 180. The first rib 178 can be disposed adjacent the outer wall 172. Similarly to the outer wall 172, the first rib 178 and the second rib 180 can each have a varied width, with a top of the rib 178, 180 having a larger width than a bottom of the rib 178, 180, for example. Each of the outer wall 172, the first rib 178, and the second rib 180 can have different widths to facilitate movement of the fruit such that where fruit is pushed against a portion with a different width, the fruit is jostled around and falls into the waste receptacle 112.

The first rib 178 can have a first curved portion 182 and the second rib 180 can have a second curved portion 184. The first curved portion 182 and the second curved portion 184 can have a different slope to the respective curved portions 182, 184. As shown in FIG. 10, the outer wall curved portion 176, the first curved portion 182, and the second curved portion 184 can have different slopes and the outer wall curved portion 176, the first curved portion 182, and the second curved portion 184 can be disposed at different areas along the lengths of the outer wall 172, the first rib 178, and the second rib 180, respectively. Advantageously, the varied widths of the outer wall 172, the first rib 178, and the second rib 180 can militate against fruit accumulation in the housing 102. The outer wall curved portion 176, the first curved portion 182, and the second curved portion 184 can push fruit into the waste receptacle 112 where fruit begins to accumulate.

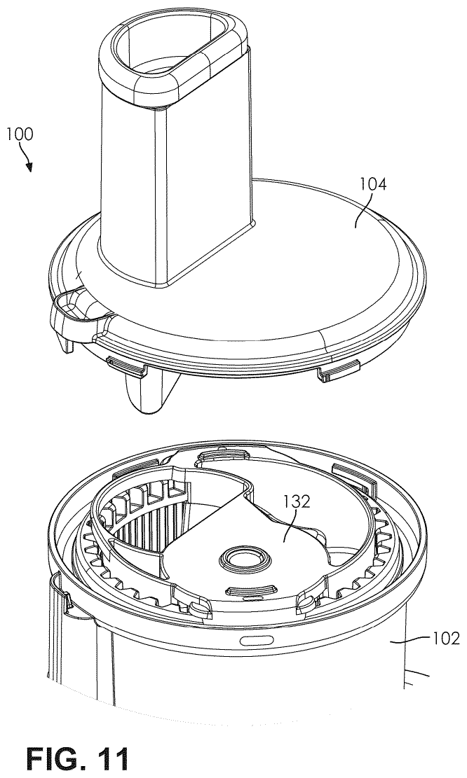

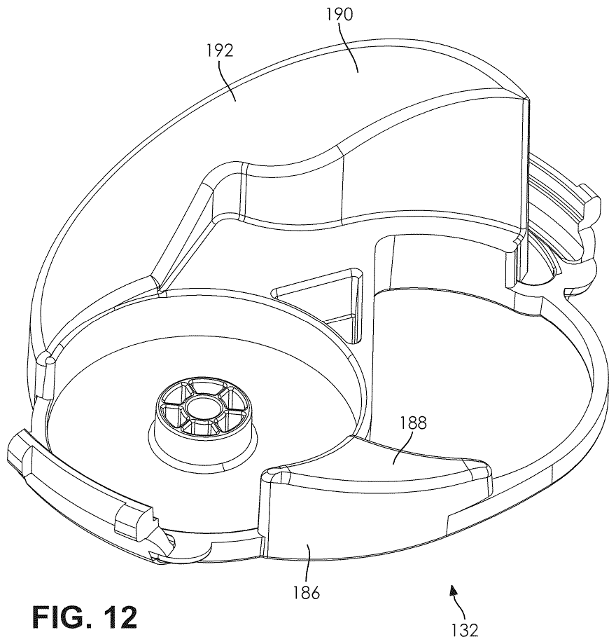

With reference to FIGS. 11 and 12, the cover 132 can include an inlet guide 186 disposed adjacent to the sloped upper surface 150 when the cover 132 is in place. The inlet guide 186 can have a sloped surface 188. The inlet sloped surface 188 can direct and guide the unsqueezed fruit toward the juicing point (P) between the outer auger 124 and the inner auger 126. The inlet guide 186 can also militate against the fruit moving upward with the housing 102 against the lid 104 instead of moving through the inner auger 124 and the outer auger 126. The cover 132 can include an outlet guide 190 disposed adjacent to the ribs 168. The outlet guide 190 can have an outlet sloped surface 192. The outlet sloped surface 192 can guide the squeezed fruit to the waste receptable 112 to militate against pulp accumulation in the juicing assembly 106.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A household citrus juicer for juicing fruit, comprising:
a housing;
a juicing assembly having:
an outer auger having inner gear teeth,
an inner auger having a sleeve having outer gear teeth, the outer gear teeth of the inner auger intermeshed with the inner gear teeth of the outer auger,
a slide configured to guide the fruit to a juicing point defined by a gap between the inner gear teeth of the outer auger and the outer gear teeth of the inner auger, the slide including a rib for moving the fruit within the juicing assembly, and
a cover disposed adjacent the inner auger and configured to align the inner auger within the juicing assembly,
wherein the inner auger and the outer auger are configured to selectively move to squeeze the fruit at the juicing point to produce juice and waste;
a lid removably coupled to the housing;
a motor to rotate the inner auger, and the inner auger is configured to rotate the outer auger via the intermeshed inner gear teeth and outer gear teeth;
a juice port in fluid communication with the juicing assembly and configured to receive the juice from the fruit squeezed at the juicing point of the juicing assembly; and
a waste receptacle configured to receive the waste from the juicing assembly.

2. The household citrus juicer of claim 1, wherein the rib is disposed within a cavity adjacent a sloped upper surface of the slide.

3. The household citrus juicer of claim 2, wherein the rib extends from an upper surface of the cavity.

4. The household citrus juicer of claim 2, wherein the cavity is formed by an outer wall disposed adjacent the inner auger.

5. The household citrus juicer of claim 4, wherein the outer wall has a varied width such that a top of the outer wall has a different width than a bottom of the outer wall.

6. The household citrus juicer of claim 5, wherein the top of the outer wall has a larger width than the bottom of the outer wall.

7. The household citrus juicer of claim 6, wherein the outer wall has a curved edge to account for the varied width.

8. The household citrus juicer of claim 5, wherein the outer wall has an outer wall curved portion disposed between the top of the outer wall and the bottom of the outer wall.

9. The household citrus juicer of claim 1, wherein the rib includes a first rib and a second rib.

10. The household citrus juicer of claim 9, wherein the first rib is disposed adjacent the outer wall.

11. The household citrus juicer of claim 9, wherein the first rib and the second rib each have a varied width, with a top of each of the first rib and the second rib having a larger width than a bottom of each of the first rib and the second rib.

12. The household citrus juicer of claim 9, wherein the first rib has a first curved portion and the second rib has a second curved portion.

13. The household citrus juicer of claim 12, wherein the first curved portion and the second curved portion have different slopes.

14. The household citrus juicer of claim 1, wherein the cover includes an inlet guide disposed adjacent to a sloped upper surface of the slide.

15. The household citrus juicer of claim 14, wherein the inlet guide has a sloped surface configured to direct and guide un-squeezed fruit toward the juicing point between the outer auger and the inner auger.

16. The household citrus juicer of claim 1, wherein the cover includes an outlet guide disposed adjacent to the rib.

17. The household citrus juicer of claim 16, wherein the outlet guide has an outlet sloped surface configured to guide squeezed fruit to the waste receptacle.

18. A household citrus juicer kit, comprising:
a household citrus juicer for juicing fruit, having
a housing,
a juicing assembly having:
an outer auger having inner gear teeth,
an inner auger having a sleeve having outer gear teeth, the outer gear teeth of the inner auger intermeshed with the inner gear teeth of the outer auger,
a slide configured to guide the fruit to a juicing point defined by a gap between the inner gear teeth of the outer auger and the outer gear teeth of the inner auger, the slide including a rib for moving the fruit within the juicing assembly, and
a cover disposed adjacent the inner auger and configured to align the inner auger within the juicing assembly,
wherein the inner auger and the outer auger are configured to selectively move to squeeze the fruit at the juicing point to produce juice and waste;
a lid removably coupled to the housing,
a motor to rotate the inner auger, and the inner auger is configured to rotate the outer auger via the intermeshed inner gear teeth and outer gear teeth,
a juice port in fluid communication with the juicing assembly and configured to receive the juice from the fruit squeezed at the juicing point of the juicing assembly, and
a waste receptacle configured to receive the waste from the juicing assembly; and
a plurality of sleeves, each sleeve of the plurality of sleeves configured to be disposed on the inner auger, each sleeve of the plurality of sleeves having outer gear teeth configured to intermesh with the inner gear teeth of the outer auger, and each sleeve of the plurality of sleeves having a different diameter.

19. The household citrus juicer kit of claim 18, wherein the plurality of sleeves includes a first sleeve and a second sleeve.

20. A method of using a household citrus juicer kit, comprising:
providing a household citrus juicer for juicing fruit kit, having
a housing
a juicing assembly having:
an outer auger having inner gear teeth,
an inner auger having a sleeve having outer gear teeth, the outer gear teeth of the inner auger intermeshed with the inner gear teeth of the outer auger,
a slide configured to guide the fruit to a juicing point defined by a gap between the inner gear teeth of the outer auger and the outer gear teeth of the inner auger, the slide including a rib for moving the fruit within the juicing assembly, and
a cover disposed adjacent the inner auger and configured to align the inner auger within the juicing assembly,
wherein the inner auger and the outer auger are configured to selectively move to squeeze the fruit at the juicing point to produce juice and waste;
a lid removably coupled to the housing,
a motor to rotate the inner auger, and the inner auger is configured to rotate the outer auger via the intermeshed inner gear teeth and outer gear teeth,
a juice port in fluid communication with the juicing assembly and configured to receive the juice from the fruit squeezed at the juicing point of the juicing assembly, and
a waste receptacle configured to receive the waste from the juicing assembly; and
installing the sleeve onto the inner auger, wherein the sleeve changes the gap between the inner gear teeth of the outer auger and the outer gear teeth of the inner auger.
